(19) United States
(12) Patent Application Publication
(10) Pub. No.: US 2006/0250944 A1
(43) Pub. Date: Nov. 9, 2006

(54) Apparatus and method for transmitting bit-interleaved coded modulation signals in an orthogonal frequency division multiplexing system

(75) Inventors: Sung-Kwon Hong, Seoul (KR); Jin-Kyu Koo, Suwon-si (KR); Dong-Seek Park, Yongin-si (KR); Young-Kwon Cho, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/399,219

(22) Filed: Apr. 6, 2006

(30) Foreign Application Priority Data
Apr. 6, 2005 (KR) 10-2005-0028724

(51) Int. Cl. H04J 11/00

(52) U.S. Cl. 370/210

(57) ABSTRACT

Disclosed is an apparatus for transmitting a bit-interleaved coded modulation (BICM) signal in an orthogonal frequency division multiplexing (OFDM) system. A serial-to-parallel (S/P) converter generates bit streams using coded bits according to the number of transmission antennas and a modulation order of a predetermined modulation scheme. An interleaver applies at least one offset to the bit streams and performs interleaving on the offset-applied bit streams. A combiner combines the interleaved bit streams according to the number of transmission antennas.

### PRIORITY

This application claims the benefit under 35 U.S.C. § 119(a) of an application filed in the Korean Intellectual Property Office on Apr. 6, 2005 and assigned Serial No. 2005-28724, the entire contents of which are incorporated herein by reference.

### BACKGROUND OF THE INVENTION

1. Field of the Invention

The present invention relates generally to an Orthogonal Frequency Division Multiplexing (OFDM) system using a Multiple Input Multiple Output (MIMO) technique, and in particular, to an apparatus and method for transmitting Bit-Interleaved Coded Modulation (BICM) signals.

2. Description of the Related Art

There is ongoing research into a 4^{th} Generation (4G) communication system to provide users with services having various qualities-of-service (QoS) at a high data rate. The 4G communication system is the next generation communication system. A focus of the research into the 4G communication system is to support high-speed services that guarantee mobility and QoS for Broadband Wireless Access (BWA) communication systems such as a wireless Local Area Network (LAN) system and a wireless Metropolitan Area Network (MAN) system.

Another focus of the research into the 4G communication system is on an OFDM scheme which is suitable for high-speed data transmission over wire/wireless channels. The OFDM scheme, a technique for transmitting data using multiple carriers, is like a Multi-Carrier Modulation (MCM) scheme that converts a serial input symbol stream into parallel symbols and modulates each of the parallel symbols with a plurality of orthogonal sub-carriers before transmission.

A communication system employing the OFDM scheme (an “OFDM communication system”) uses a Trellis Coded Modulation (TCM) scheme as a modulation scheme. The TCM scheme obtains a high coding gain without a decrease in data rate and an increase in bandwidth by performing coding and modulation on a combined basis instead of separately performing the coding and the modulation. The TCM scheme designs, as a symbol-based coding scheme, a coder such that a set partitioning-based signal mapping technique maximizes a Euclidean distance for a modulation scheme which is higher in modulation order than Binary Phase Shift Keying (BPSK).

A communication system employing the TCM scheme could obtain a coding gain even without an increase in the bandwidth due to the characteristics described above. Therefore, in the TCM scheme, no interleaver is taken into consideration, and a coder is directly coupled to modulation mappers. In the communication system, when a convolutional encoder is coupled to modulation mappers (i.e., mappers to which a modulation technique is applied), the system performance in a fading channel will be greatly affected depending on the minimum number of symbols where there is a difference between a transmission sequence and an error sequence of the encoder.

Herein, the minimum distance of the error sequence is referred to as “time diversity”. A BICM scheme, compared with the TCM scheme, has a greater time diversity value. In the BICM scheme, the time diversity is defined as a minimum Hamming distance of a binary convolutional code, and always has a greater value than a symbol-based distance of binary or higher order, obtained in the TCM scheme. An interleaver applied in the BICM scheme obtains great time diversity by removing correlations between bits.

The BICM scheme has a characteristic capable of performing iterative decoding in addition to the characteristic of great time diversity.

The BICM scheme, due to the characteristic capable of performing iterative decoding, is attracting attention after concatenated codes such as turbo codes have attracted attention and an increased interest in the iterative decoding. The BICM scheme can perform the iterative decoding by considering a concatenated input signal as a serially concatenated code due to an interleaver between the convolutional encoder and the modulation mappers.

The output signal of BICM modulation mappers have no error correction capability for channel codes. Therefore, performance improvement of the modulation mappers obtainable by the iterative decoding is caused by a difference in demodulation detection capability based on a mapping rule applied to same. As a result, a change in the mapping rule applied to the modulation mappers causes a change in the performance.

Part of the ongoing research into the 4G mobile communication system focuses on a multi-antenna scheme for overcoming the limited bandwidth allocated therefor, i.e., increasing a data rate, as well as the OFDM scheme. The multi-antenna scheme overcomes the limited frequency band resource because it uses the space domain.

A description of a space diversity scheme in the multi-antenna scheme is set forth below.

The space diversity scheme is generally used for the channels with a low delay spread, such as an indoor channel and a pedestrian channel, which is a low speed Doppler channel. The space diversity scheme acquires a diversity gain by using two or more antennas. When a signal transmitted via a particular transmission antenna is attenuated by fading, the space diversity receives signals transmitted via the remaining transmission antennas, thereby acquiring a diversity gain.

The space diversity scheme is classified into a transmission antenna diversity scheme using a plurality of transmission antennas, a reception antenna diversity scheme using a plurality of reception antennas, a Multiple Input Multiple Output (MIMO) scheme using a plurality of transmission antennas and a plurality of reception antennas.

Generally, the MIMO scheme increases a data rate by using a spatial multiplexing scheme and a Space-Time Coding (STC) scheme. Referring to FIG. 1, below is a description of a structure of a BICM transmission apparatus in an OFDM system employing the MIMO scheme (hereinafter referred to as a “MIMO-OFDM system”).

FIG. 1 is a diagram schematically illustrating a structure of a BICM transmission scheme in a general MIMO-OFDM system.

Before a description of FIG. 1 is given, it is noted that the BICM transmitter generally includes cascaded convolutional encoder, interleaver, and modulation mappers.

Assume that the convolutional encoder generally generates a binary code designed such that it has a maximum Hamming distance at a predetermined constraint length.

The interleaver removes time correlations between input bits so that they are independent of each other. In addition, the interleaver can create independent bit streams but perform interleaving regardless of the bit streams. The signal received from the convolutional encoder via the interleaver obtains diversity effect.

Assume that the modulation mappers, when applied to the BICM scheme, generally use a modulation scheme having a higher modulation order than that of BPSK. Therefore, the modulation mappers combine the bits according to size of modulation symbols in a predetermined order from the bit stream output from the interleaver, and map the modulation symbols at a baseband according to a predetermined mapping rule.

Referring to FIG. 1, the BICM transmission apparatus of the MIMO-OFDM system includes a convolutional encoder 101, an interleaver 103, a serial-to-parallel (S/P) converter 105, modulation mappers 107, and OFDM modulators 109.

If information data bits such as user data bits and control data bits are generated, the convolutional encoder 101 receives and encodes the information data bits using a predetermined coding scheme applied thereto. The coding scheme applied to the encoder includes a convolutional coding scheme having a predetermined coding rate. The information data bits encoded by the convolutional encoder 101 using the convolutional coding scheme are input to the interleaver 103.

The interleaver 103 performs sequence permutation on the input information data bits, divides the sequence-permutated information data bits into parallel bit streams, the number of which is equal to a modulation order of the last modulation scheme, and performs independent interleaving on the bit streams. The bits interleaved by the interleaver 103 are input to the S/P converter 105.

The S/P converter 105 S/P-converts the coded bits according to the number of antennas, and distributes the S/P-converted coded bits according to the number of transmission antennas. Generally, in the transmission system, information transmission is processed in units of blocks each comprised of bit sets with a predetermined size according to the number of the transmission antennas. The separated blocks are input to the modulation mappers 107.

The modulation mappers 107 group the input bits into channel symbols according to a modulation order.

The OFDM modulators 109 perform OFDM modulation on symbol sets with a Fast Fourier Transform (FFT) size. The OFDM modulation includes performing Inverse Fast Fourier Transform (IFFT) and performing Cyclic Prefix (CP) insertion. Therefore, the OFDM modulators 109 perform IFFT on the received symbol sets, insert CPs in the IFFT-processed symbol sets, and then transmit the CP-inserted symbol sets via corresponding antennas.

The BICM transmission apparatus of the MIMO-OFDM system transmits the OFDM-modulated channel symbols to its associated BICM reception apparatus of the MIMO-OFDM system, and a structure of the BICM reception apparatus will now be described with reference to the schematic diagram of FIG. 2.

Referring to FIG. 2, the BICM reception apparatus of the MIMO-OFDM system includes OFDM demodulators 201, a demapper 203, a parallel-to-serial (P/S) converter 205, a deinterleaver 207, a MAP decoder 209, an interleaver 211, and an S/P converter 213.

The OFDM demodulators 201 receive transmission signals from the OFDM transmission apparatus via reception antennas. The OFDM demodulators 201 perform OFDM demodulation on the signals received via their associated reception antennas. That is, the OFDM demodulators 201 demodulate the transmission signals received from the OFDM transmission apparatus over the corresponding channels, by performing CP removing and FFT on the received transmission signals.

The signals extracted from the reception antennas, after undergoing CP removing and FFT, are combined and then used for iterative decoding. The demapper 203 extracts binary Log Likelihood Ratio (LLR) values for the iterative decoding from the signals demodulated by the OFDM demodulators 201 in units of symbols. The demapper 203 outputs the LLR values to the P/S converter 205.

The P/S converter 205 converts the input parallel signals into a serial signal and outputs the serial signal to the deinterleaver 207.

The deinterleaver 207 deinterleaves the extracted LLR values, and encodes the deinterleaved LLR values in their output order in an encoder of the transmission apparatus. An output signal of the deinterleaver 207 is input to the MAP decoder 209, and the MAP decoder 209 extracts a soft decision value decoded through a MAP algorithm. The decoded value extracted by the MAP decoder 209 is input to the interleaver 211, and the interleaver 211 interleaves the decoded value and outputs the interleaved signal to the S/P converter 213. The S/P converter 213 converts the interleaved serial signal into parallel signals and outputs the parallel signals to the demapper 203. The demapper 203 reuses the parallel signals output from the S/P converter 213. Therefore, the operation process of the MIMO-OFDM reception apparatus forms a loop and iterates the process in the loop, performing iterative decoding. The decoded LLR values enable the reception apparatus to extract reliable channel information in the demapping process, so an increase in the iteration reduces a hard decision error rate.

In a frequency selective fading environment of the current mobile communication system, the OFDM signal is subject to performance improvement through interleaving. The frequency selective fading environment can be modeled as a structure of a tapped delay line (TDL) with several taps coupled to each other.

In addition, according to the tap interval and relative power levels of the taps, the OFDM signal suffers from different fading at every frequency in a frequency spectrum. Therefore, the OFDM signal can have channels with a better channel state and channels with a worse channel state according to the frequencies, and it is possible to obtain a diversity gain by appropriately mixing the channels before encoding. However, in the transmission apparatus of the current OFDM system, the interleaver cannot take into account the correlations between antennas and the FFT size in performing interleaving. The BICM interleaver of the OFDM system cannot make the best use of the diversity occurring in the OFDM signal, and needs high complexity in structure. In conclusion, the OFDM system based on the existing BICM scheme is not optimized in terms of an interleaving method and interleaver design according thereto.

### SUMMARY OF THE INVENTION

It is, therefore, an object of the present invention to provide an apparatus and method for transmitting Bit-Interleaved Coded Modulation (BICM) signals in an Orthogonal Frequency Division Multiplexing (OFDM) system.

It is another object of the present invention to provide a signal transmission apparatus and method for performing interleaving taking into account correlations between antennas and a Fast Fourier Transform (FFT) size in an OFDM system.

It is further another object of the present invention to provide a signal transmission apparatus and method for performing interleaving so as to best utilize BICM diversity in an OFDM system.

If is yet another object of the present invention to provide a signal transmission apparatus and method with reduced complexity in an OFDM system to applied BICM scheme.

According to one aspect of the present invention, there is provided an apparatus for transmitting a bit-interleaved coded modulation (BICM) signal in an orthogonal frequency division multiplexing (OFDM) system. The apparatus includes a serial-to-parallel (S/P) converter for generating bit streams using coded bits according to the number of transmission antennas and a modulation order of a predetermined modulation scheme; an interleaver for applying at least one offset to the bit streams and performing interleaving on the offset-applied bit streams; and a combiner for combining the interleaved bit streams according to the number of transmission antennas.

According to another aspect of the present invention, there is provided a method for transmitting a bit-interleaved coded modulation (BICM) signal in an orthogonal frequency division multiplexing (OFDM) system. The method includes generating bit streams using coded bits according to the number of transmission antennas and a modulation order of a predetermined modulation scheme; applying at least one offset to the bit streams and performing interleaving on the offset-applied bit streams; and combining the interleaved bit streams according to the number of transmission antennas.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram schematically illustrating a structure of a BICM transmission scheme in a general MIMO-OFDM system;

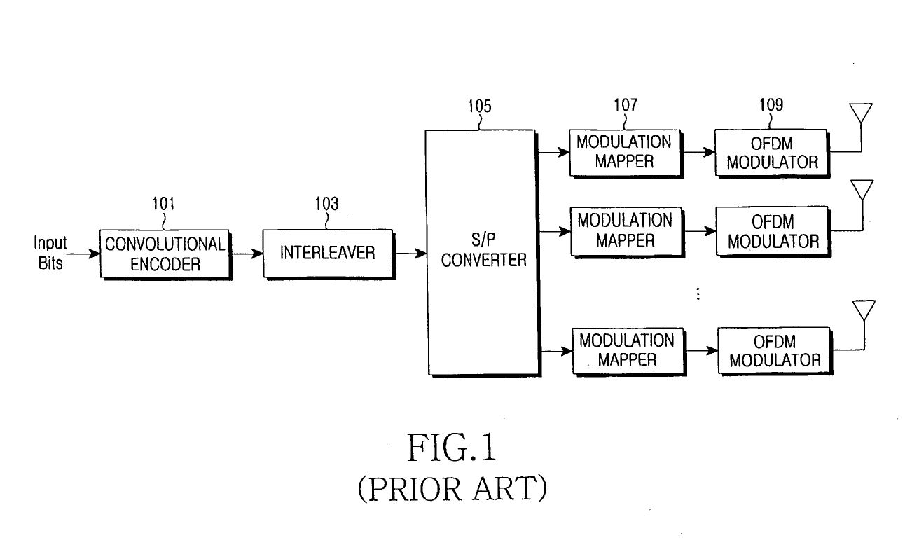

FIG. 2 is a diagram schematically illustrating a structure of a BICM reception apparatus in a general MIMO-OFDM system;

FIG. 3 is a diagram schematically illustrating a structure of a BICM transmission apparatus in a MIMO-OFDM system according to the present invention;

FIG. 4 is a flowchart schematically illustrating an operation method of a BICM transmission apparatus in a MIMO-OFDM system according to the present invention;

FIG. 5 is a flowchart schematically illustrating an operation process of a BICM reception apparatus in a MIMO-OFDM system according to the present invention; and

FIG. 6 is a graph illustrating BICM performance curves in a MIMO-OFDM system according to the present invention.

### DETAILED DESCRIPTION OF PREFERRED EMBODIMENTS

Preferred embodiments of the present invention will now be described in detail with reference to the annexed drawings. In the following description, a detailed description of known functions and configurations incorporated herein has been omitted for clarity and conciseness.

The present invention provides a signal transmission apparatus and method for performing Bit-Interleaved Coded Modulation (BICM) interleaving in a Multiple Input Multiple Output (MIMO)-Orthogonal Frequency Division Multiplexing (OFDM) system. The signal transmission apparatus and method makes sub-interleaver blocks having a plurality of offsets for an interleaver, and performs interleaving taking into account the number of antennas, a modulation order, and a Fast Fourier Transform (FFT) size.

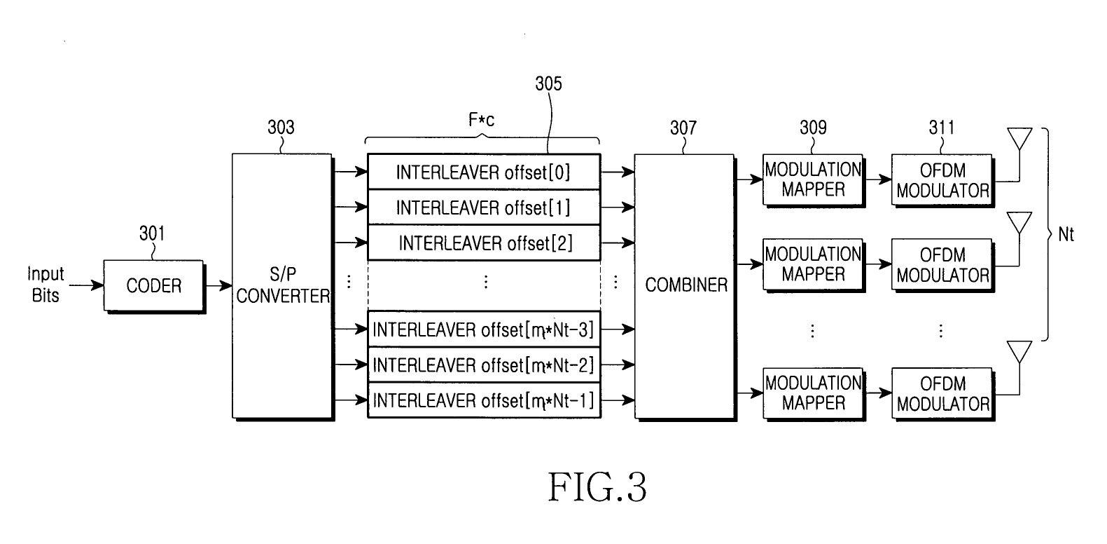

Before a description of the present invention is given, it should be noted that a transmission frequency, i.e., the number of transmission antennas, is denoted by Nₜ and a reception frequency, i.e., the number of reception antennas, is denoted by Nᵣ. In addition, an FFT size of an OFDM symbol is denoted by F, and an M-ary modulation scheme is used. Referring to FIG. 3, below is a description made of a structure of a MIMO-OFDM transmission apparatus according to the present invention.

FIG. 3 is a diagram schematically illustrating a structure of a BICM transmission apparatus in a MIMO-OFDM system according to the present invention.

A detailed description of the same structure and operation as that of the conventional BICM transmission apparatus will be omitted herein for simplicity.

Referring to FIG. 3, the BICM transmission apparatus of the MIMO-OFDM system includes a coder 301, a serial-to-parallel (S/P) converter 303, an interleaver 305, a combiner 307, modulation mappers 309, and OFDM modulators 311.

The coder 301 performs coding with a code having a coding rate of, for example, k/n, and outputs the coding result to the S/P converter 303. Herein, k denotes information symbol, i.e., input information bits, and n denotes a length of a code, i.e., a length of output coded bits.

The S/P converter 303 S/P-converts the code of the coder 301 and outputs the S/P conversion result to the interleaver 305. The bit streams input to the interleaver 305 are m*Nt bit streams, which are interleaved by associated sub-interleavers with a size F*c. A size of the bit streams input to the interleaver 305 is F*m*Nₜ*c. Herein, F denotes an FFT size, and m denotes a modulation order obtained from M=2ₘ for the M-ary modulation scheme. In addition, Nₜ denotes the number of transmission antennas, and c denotes a positive integer.

The interleaver 305, as it has the above structure, reflects a diversity effect between frequencies or between antennas, occurring in an OFDM symbol, in the code output from the coder 301. If there is no correlation between antennas, it is also possible to divide the input code into m bit streams. However, the input code is divided into m*Nt bit streams taking into account correlations between antennas, occurring in the actual OFDM system.

The interleaver 305 is preferably a random interleaver. Generally, for a block interleaver showing optimal performance, an interleaver depth depends upon channel conditions. However, because the channel condition is a time-varying parameter and it is not possible to obtain appropriate and accurate information thereon, it is preferable to use a random interleaver so as to adapt to the time-varying situation, rather than using the block interleaver.

The interleaver 305 includes the same sub-interleavers for the parallel bit streams output from the S/P converter 303, and sets different relative offsets for the sub-interleavers. As described above, the interleaver 305 is constructed in such a manner that different offsets are set for the sub-interleavers for the bit streams. Therefore, the interleaver 305 interleaves the bit streams through their associated sub-interleavers. As a result, the interleaver 305 performs interleaving the beat streams by means of the different offsets.

The sub-interleavers mapped to their associated bit streams will be denoted by IL_{P}[x] (for x=0, . . . ,F*c−1) and the full interleaver 305 will be denoted by IL[x]. In this case, the interleaver 305 can be expressed with an equation, and IL[x] indicates that an x^{th} bit is interleaved into an IL[x]^{th} bit. For example, an equation of IL[10]=23 indicates that an 11^{th} bit position (herein, an index is given from 0) before interleaving changes to a 24^{th} bit position after the interleaving.

The interleaver 305 is expressed by Equation (1) below, in which the values expressed in units of real numbers less than or equal to integers are discarded.
IL[j*Nₜ*m+i]=ILₚ[(j+offset[i])%(F*c)]*Nₜ*m+i, for i=0, . . . ,Nₜ*m, j=0, . . . ,F*c−1 (1)

Equation (1) takes correlations between antennas into account, and i and j express a one-to-one relationship between interleaved sequences and all sequences with a size of Nₜ*m*F*c when they are changed within a given range. In addition, ILₚ[ ] denotes a random interleaver in bits.

When the correlations between antennas are not taken into consideration, the interleaver 305 is expressed by Equation (2) below:
IL[j*m+i]=ILₚ[(j+offset[i])%(F*Nₜ*c)]*m+i, for i=0, . . . ,m, j=0, . . . , F*N,*c−1 (2)

In addition, offset[i] shown in Equation (1) and Equation (2) denotes offsets of the sub-interleavers included in the interleaver 305. A method for finding offsets of the sub-interleavers can be divided into one method for finding the offsets taking the correlations between antennas into account and another method for finding the offsets without taking the correlations between antennas into account, and the former method can be divided again into two methods according to the correlations between antennas.

When the correlations between antennas are taken into account, offsets applied to the sub-interleavers are expressed as in Equation (3) and (4) below:

$$\begin{matrix}offset [ i ] = ⌊ \frac{F * c}{{N}_{t} * m} * i ⌋ , i = 0 , ⋯ , ⌊ \frac{F * c}{{N}_{t} * m} ⌋ - 1 & ( 3 ) \\ offset [ i ] = ⌊ \frac{F * c}{{N}_{t} * m} * Br [ i ] ⌋ , i = 0 , ⋯ , ⌊ \frac{F * c}{{N}_{t} * m} ⌋ - 1 & ( 4 )\end{matrix}$$

When offset[i] is found using Equation (3), the offsets have a fixed interval.

In Equation (4), a bit reversing function is used to reduce correlations between bit streams. In addition, BR[i] denotes a value determined by performing bit reversing on i with an 1-bit size of a minimum value

$$⌊ \frac{F * c}{{N}_{t} * m} ⌋ \leq {2}^{l} .$$

For example, a value determined by performing bit reversing on 3 expressed with a 4-bit binary number of ‘0011’ is 12 and is expressed as a binary number of ‘1100’.

For Nₜ=2, F=64, c=1, and m=2 in Equation (3) and Equation (4), (F*c)/(Nₜ*m))=64*½*2=16. In this case, Equation (3) has values of offset[0]=0, offset[1]=16, offset[2]=32, and offset[4]=64, and Equation (4) has values of offset[0]=0, offset[1]=32, offset[2]=48, and offset[4]=16.

When the correlations between antennas are not taken into consideration, offsets applied to the sub-interleavers are given by Equations (5) and (6) below:

$$\begin{matrix}offset [ i ] = ⌊ \frac{F * {N}_{t} * c}{m} * i ⌋ , i - 0 , ⋯ , ⌊ \frac{F * {N}_{t} * c}{m} ⌋ - 1 & ( 5 ) \\ offset [ i ] = ⌊ \frac{F * {N}_{t} * c}{m} * BR [ i ] ⌋ , i = 0 , ⋯ , ⌊ \frac{F * {N}_{t} * c}{m} ⌋ - 1 & ( 6 )\end{matrix}$$

Similarly, when offset[i] is found using Equation (5), the offsets have a fixed interval.

In Equation (6), a bit reversing function is used to reduce correlations between bit streams. Similarly, BR[i] denotes a value determined by performing bit reversing on i with an 1-bit size of a minimum value

$$⌊ \frac{F * {N}_{t} * c}{m} ⌋ \leq {2}^{l} .$$

The interleaver 305 performs interleaving through the sub-interleavers to which the offsets are applied, and outputs the interleaving results to the combiner 307. The combiner 307 combines the bit streams interleaved according to the number of antennas, separates the combined bit stream back into parallel bit streams according to a modulation order and correlations between transmission antennas, and outputs the resultant parallel bit streams to the modulation mappers 309. The modulation mappers 309 group the input bits into channel symbols according to a modulation order, and outputs the channel symbols to the OFDM modulators 311. The OFDM modulators 311 perform OFDM modulation, i.e., Inverse Fast Fourier Transform (IFFT), on the input channel symbols, insert CPs in the IFFT-processed channel symbols, and then transmit the CP-inserted channel symbols to a reception apparatus associated with the transmission apparatus, via transmission antennas.

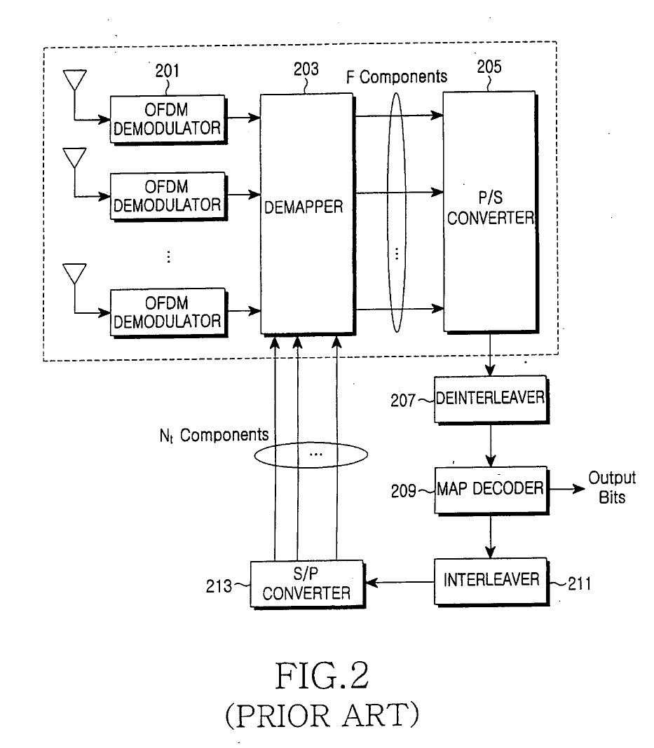

The BICM reception apparatus of the MIMO-OFDM system is similar in structure to the reception apparatus shown in FIG. 2. However, the structure of the BICM reception apparatus is subject to change according to the present invention.

In the reception apparatus, a deinterleaver can perform deinterleaving using the existing deinterleaver. Herein, the “deinterleaving” refers to the reverse process of the interleaving and means a process of restoring bit positions to their original bit positions before interleaving. In addition, the deinterleaving can be expressed as IL⁻¹[x]. However, for an efficient decoding scheme, it is possible to modify the deinterleaver such that it performs a deinterleaving operation using a plurality of inner deinterleavers, i.e., sub-deinterleavers, having a plurality of offsets, like the interleaver.

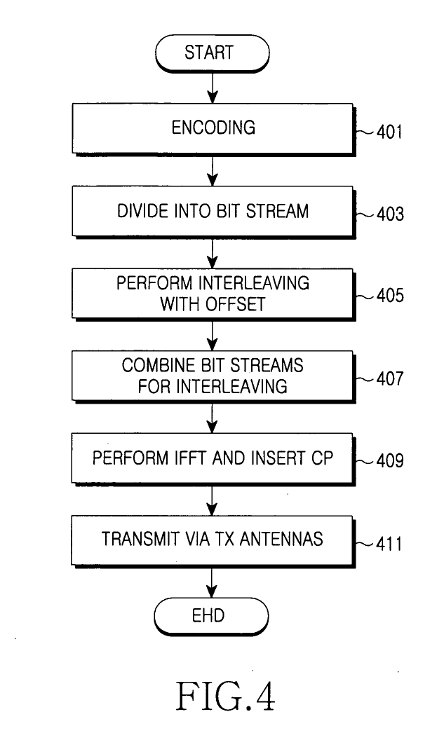

The BICM transmission apparatus in the MIMO-OFDM system has been described so far with reference to FIG. 3. Next, with reference to the flowchart of FIG. 4, a description will be made of an operation method of the BICM transmission apparatus in the MIMO-OFDM system according to the present invention.

Referring to FIG. 4, upon receiving information bits from the MIMO-OFDM system, the transmission apparatus encodes the input information bits in step 401.

In step 403, the transmission apparatus divides the coded bits into a plurality of bit streams by performing S/P conversion, in order to apply independent offsets to the bit streams before interleaving. Herein, the interleaving may be performed by a random interleaver according to a random interleaving rule.

In step 405, the transmission apparatus applies independent offsets to the bit streams and performs interleaving taking into account an FFT size and correlations between antennas. A structure of an interleaver for the interleaving is expressed as Equation (1) and Equation (2), and the offsets applied to the bit streams are shown in Equation (3), Equation (4), Equation (5) and Equation (6).

In step 407, the transmission apparatus combines the interleaved bit streams according to a modulation order and correlations between transmission antennas. In step 409, the transmission apparatus groups the combined bit streams into channel symbols according to a modulation order. In addition, the transmission apparatus performs OFDM modulation, i.e., IFFT, and CP insertion. In step 411, the transmission apparatus transmits the OFDM-modulated signals via corresponding transmission antennas.

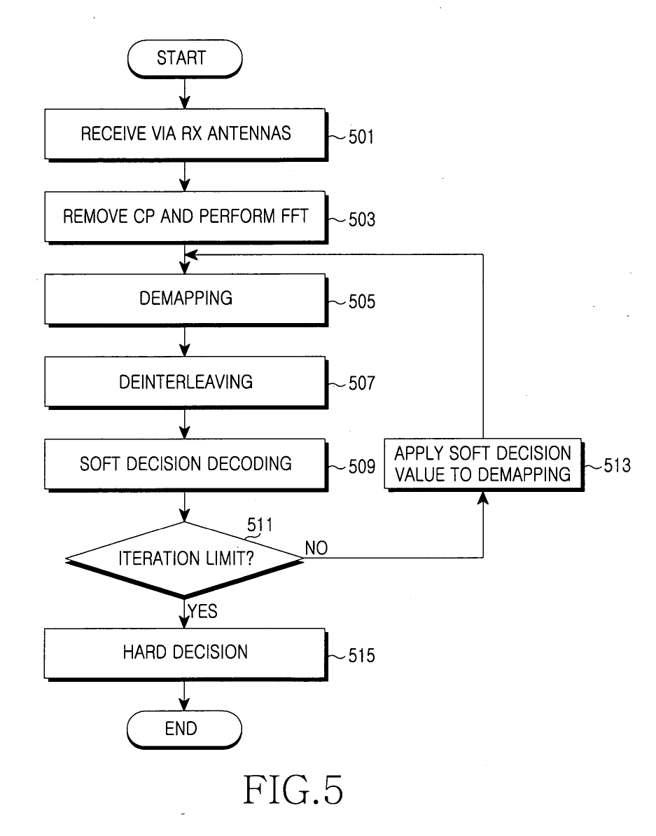

Referring to the flowchart of FIG. 5, a description will now be made of an operation process of a BICM reception apparatus associated with the BICM transmission apparatus of the MIMO-OFDM system.

Referring to FIG. 5, the reception apparatus receives signals transmitted from the transmission apparatus via corresponding reception antennas in step 501.

In step 503, the reception apparatus removes CPs from the received signals and performs FFT on the CP-removed signals. That is, the reception apparatus performs OFDM demodulation on the signals received via their associated reception antennas. In step 505, the reception apparatus performs demapping on the OFDM-demodulated signals and converts the channel symbols back into bits.

In step 507, the reception apparatus performs deinterleaving corresponding to the interleaving to restore the demapped signals to the bit streams before interleaving. The reception apparatus extracts LLR values in units of bits for the signals demodulated in units of symbols, and performs deinterleaving on the extracted LLR values. In step 509, the reception apparatus extracts a decoded soft decision value.

In step 511, the reception apparatus determines whether an iteration of the process of up to step 509 for performing the soft decision decoding is greater than or equal to a predetermined iteration limit. If it is determined that the iteration is less than the iteration limit, the reception apparatus proceeds to step 513. However, if the iteration is greater than or equal to the iteration limit, the reception apparatus proceeds to step 515.

In step 513, the reception apparatus applies the extracted soft decision value to the demapping and then proceeds to step 505 where it performs again the demapping. In step 515, the reception apparatus performs hard decision because the iteration is greater than or equal to the iteration limit, and then demodulates the signals received from the transmission apparatus.

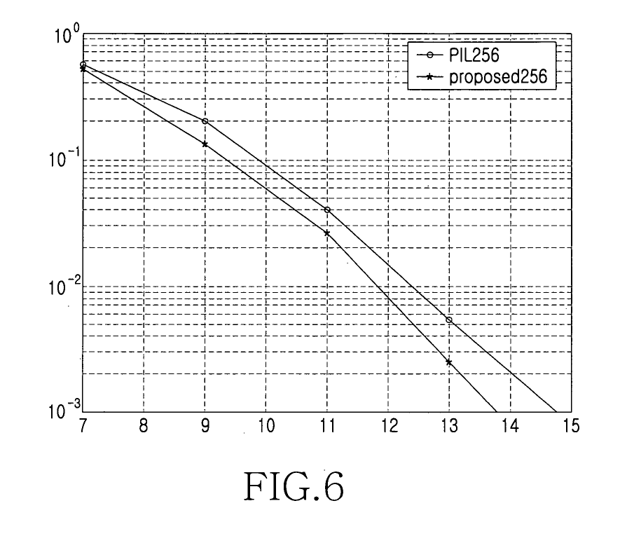

FIG. 6 is a graph illustrating BICM performance curves in a MIMO-OFDM system according to the present invention.

Referring to FIG. 6, there is shown a graph given by Equation (3) for a Prime Interleaver (PIL), which is one of random interleavers. Herein, the PIL, which is an S-random interleaver, has superior characteristics and can be constructed in various sizes at low complexity. That is, FIG. 6 illustrates a measured block error rate of the PIL.

For example, for Nₜ=2, Nᵣ−1, F=64, m=2 (QPSK), c=1, and 1=2, a size of a sub-interleaver (PIL) ILₚ[ ] is assumed to be 64. A mapping rule applied at this time is a Gray mapping rule. The vertical axis of the graph represents a bock error rate and the horizontal axis represents a performance gain in dB. As shown in the graph, the interleaver proposed in the present invention exhibits a performance gain of about 1 dB at a block error rate of 10⁻³ for a PIL with a size 256.

As can be understood from the foregoing description, the present invention provides a BICM interleaving apparatus and method in an OFDM system. The interleaving apparatus and method interleaves respective bit streams taking into account the number of antennas and a FFT size, thereby making the best use of diversity in the OFDM system. In addition, the interleaving apparatus and method contributes to a reduction in complexity of the interleaving process performed in the interleaver and the deinterleaver. Further, compared with the existing system, the novel system applies an optimal interleaving scheme, thereby improving the performance.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An apparatus for transmitting a bit-interleaved coded modulation (BICM) signal in an orthogonal frequency division multiplexing (OFDM) system, the apparatus comprising:
a serial-to-parallel (SIP) converter for generating bit streams using coded bits according to the number of transmission antennas and a modulation order of a predetermined modulation scheme;
an interleaver for applying at least one offset to the bit streams and performing interleaving on the offset-applied bit streams; and
a combiner for combining the interleaved bit streams according to the number of transmission antennas.

2. The apparatus of claim 1, further comprising a coder for generating coded bits by performing coding at a predetermining coding rate.

3. The apparatus of claim 1, further comprising:
a modulation mapper for grouping bits into channel symbols according to the modulation order, using bit streams whose number corresponds to the number of antennas; and
an OFDM modulator for performing inverse fast Fourier transform (IFFT) on the channel symbols, inserting a cyclic prefix (CP) into the IFFT-processed channel symbols, and transmitting the CP-inserted channel symbols via the antennas.

4. The apparatus of claim 1, wherein the interleaver interleaves the bit streams according to different offsets.

5. The apparatus of claim 1, wherein the offsets are generated using a bit reversing function.

6. The apparatus of claim 1, wherein the interleaver includes one or more sub-interleavers having different offsets.

7. The apparatus of claim 1, wherein the interleaver is constructed such that it has a size which is a multiple of a fast Fourier transform (FFT) size of a reception apparatus associated with the transmission apparatus.

8. The apparatus of claim 1, wherein the interleaver is a random interleaver.

9. A method for transmitting a bit-interleaved coded modulation (BICM) signal in an orthogonal frequency division multiplexing (OFDM) system, the method comprising the steps of:
generating bit streams using coded bits according to the number of transmission antennas and a modulation order of a predetermined modulation scheme;
applying at least one offset to the bit streams and performing interleaving on the offset-applied bit streams; and
combining the interleaved bit streams according to the number of transmission antennas.

10. The method of claim 9, further comprising generating coded bits by performing coding at a predetermining coding rate.

11. The method of claim 9, further comprising:
grouping bits into channel symbols according to the modulation order, using bit streams whose number corresponds to the number of antennas; and
performing inverse fast Fourier transform (IFFT) on the channel symbols, inserting a cyclic prefix (CP) into the IFFT-processed channel symbols, and transmitting the CP-inserted channel symbols via the antennas.

12. The method of claim 9, further comprising interleaving the bit streams according to different offsets.

13. The method of claim 9, wherein the offsets are generated using a bit reversing function.

14. The method of claim 9, wherein the interleaving is performed such that it has a size which is a multiple of a fast Fourier transform (FFT) size of a reception apparatus associated with the transmission apparatus.

15. The method of claim 9, wherein the interleaving method uses a random interleaving scheme.
